(19) United States
(12) Patent Application Publication
(10) Pub. No.: US 2018/0299721 A1
(43) Pub. Date: Oct. 18, 2018

(54) SUPPORT STRUCTURE, WALL HOLDER WITH SUPPORT STRUCTURE, AND ULTRA-THIN TELEVISION HAVING WALL HOLDER

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: NA WANG, Guangdong (CN); CHENG-FA CHUNG, New Taipei (TW); CHIH-HSIEN CHEN, New Taipei (TW)

(21) Appl. No.: 15/643,141

(22) Filed: Jul. 6, 2017

(30) Foreign Application Priority Data
Apr. 12, 2017 (CN) 201710236994.0

(51) Int. Cl. G02F 1/1333

(52) U.S. Cl. CPC G02F 1/133308; H04N 5/64

(57) ABSTRACT

An ultra-thin television includes a wall holder and a liquid crystal display screen. The wall holder includes a support structure and a plurality of accessories. The support structure includes a front frame having a decorative front surface, the front frame defines a display screen receiving space. The support structure defines an accessory receiving cavity in air communication with the display screen receiving space. The accessories are located in the receiving cavity. The liquid crystal display screen is received in the display screen receiving space and electrically connects to the accessories through a connector.

### CROSS-REFERENCE TO RELATED APPLICATIONS

This application claims priority to Chinese Patent Application No. 201710236994.0 filed on Apr. 12, 2017, the contents of which are incorporated by reference herein.

### FIELD

The subject matter herein generally relates to ultra-thin television.

### BACKGROUND

An ultra-thin television is popular. Usually, a thinner thickness of an ultra-thin television is obtained by decreasing thicknesses of electronic components in the ultra-thin television, which may be liquid crystal display screen, power supply, or printed circuit board.

### BRIEF DESCRIPTION OF THE DRAWINGS

Implementations of the present technology will now be described, by way of example only, with reference to the attached figures.

FIG. 1 is a top view of a first exemplary embodiment of an ultra-thin television.

FIG. 2 is a cross-sectional view of the ultra-thin television of FIG. 1 along line II-II.

FIG. 3 is a cross-sectional view of a second exemplary embodiment of the ultra-thin television.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain sections have been exaggerated to better illustrate details and features of the present disclosure.

Several definitions that apply throughout this disclosure will now be presented.

The term “substantially” is defined to be essentially conforming to the dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

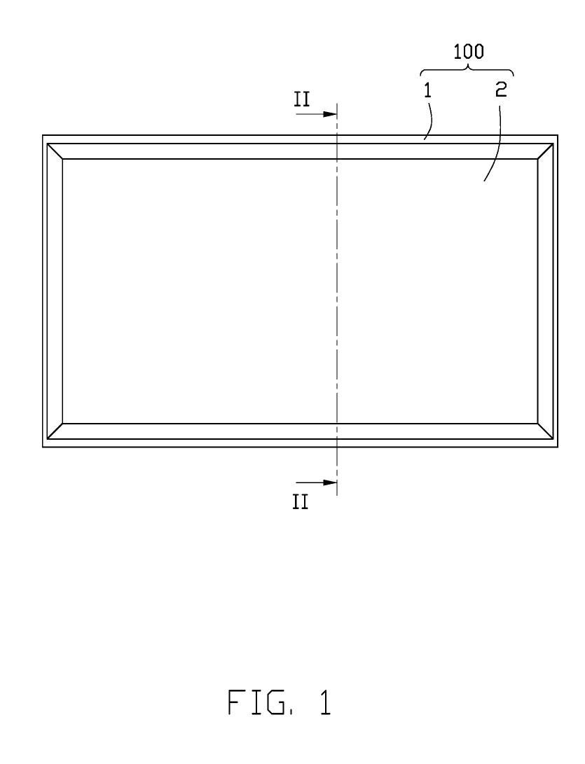

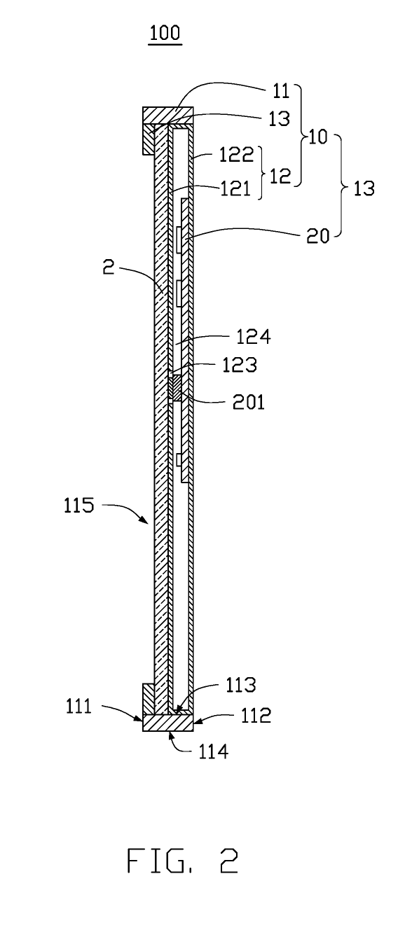

FIGS. 1 to 2 illustrate a first exemplary embodiment of an ultra-thin television 100 including a wall holder 1 for television and a liquid crystal display screen 2.

The wall holder 1 can be mounted on a wall. The wall holder 1 includes a support structure 10 and a plurality of accessories 20.

The support structure 10 includes a front frame 11 and a base board 12.

The front frame 11 is substantially a square. The front frame 11 includes a decorative front surface 111, a back surface 112, a plurality of inner side surfaces 113, and a plurality of outer side surfaces 114. The back surface 112 is on a side of the front frame opposite to the decorative front surface 111. The plurality of inner side surfaces 113 connects to the back surface 112 and the decorative front surface 111. The plurality of outer side surfaces 114 connects to the back surface 112 and the decorative front surface 111.

The plurality of inner side surfaces 113 defines a display screen receiving space 115.

The decorative front surface 111 of the front frame 11 can include geometric patterns, decorative texture, decorative patterns, embossed patterns, and others. When the wall holder 1 is mounted on a wall, the front frame 11 looks like a picture frame.

The back surface 112 can include a mounting element (not shown) to mount the front frame 11 on a wall.

The base board 12 is received in the display screen receiving space 115. The base board 12 is a hollow board. The base board 12 defines at least one accessory receiving cavity 124 in the base board 12.

In this exemplary embodiment, a thickness of the base board 12 is less than that of the front frame 11 defining the display screen receiving space 115.

The base board 12 includes a first plate 121 and a second plate 122. The second plate 122 is on a side of the base board 12 opposite to the first plate 121. The first plate 121 defines an opening 123. The at least one accessory receiving cavity 124 is in air communication with the display screen receiving space 115 through the opening 123. A position element (not shown) can be positioned on the second plate 122 to mount the base board 12 on a wall.

The plurality of accessories 20 is received in the at least one accessory receiving cavity 124. In this exemplary embodiment, the plurality of accessories 20 converges to a connector 201 and electrically connects to the connector 201. The connector 201 is positioned on the first plate 121 away from the second plate 122, and is exposed from the opening 123. The connector 201 can be a socket with electrical connection, fiber connection, or a combination of connectors.

The plurality of accessories 20 can include a printed circuit board, a speaker, a power supply, a radiator, and other accessories.

The liquid crystal display screen 2 is received in the display screen receiving space 15 on a side of the first plate 121 away from the second plate 122. The liquid crystal display screen 2 can electrically connect to the plurality of accessories 20 by the connector 201. The liquid crystal display screen 2 can be mounted on the inner side surfaces 113 of the front frame 11 or the first plate 121 of the base board 12.

Preferably, a thickness of the liquid crystal display screen 2 is less than that of the front frame 11 defining the display screen receiving space 115. An outermost surface of the liquid crystal display screen 2 away from the base board 12 is depressed from or is flush with the decorative front surface 111. In the exemplary embodiment, the outermost surface of the liquid crystal display screen 2 away from the base board 12 is depressed from the decorative front surface 111.

In this exemplary embodiment, the support structure 10 further includes a resisting frame 13 received in the display screen receiving space 15. The resisting frame 13 is positioned on one side of the liquid crystal display screen 2 away from the base board 12, to resist against the liquid crystal display screen 2 in the display screen receiving space 15. A surface of the resisting frame 13 away from the liquid crystal display screen 2 can also include geometric patterns, decorative texture, decorative patterns, embossed patterns, and the like.

In other exemplary embodiments, the resisting frame 13 can be omitted.

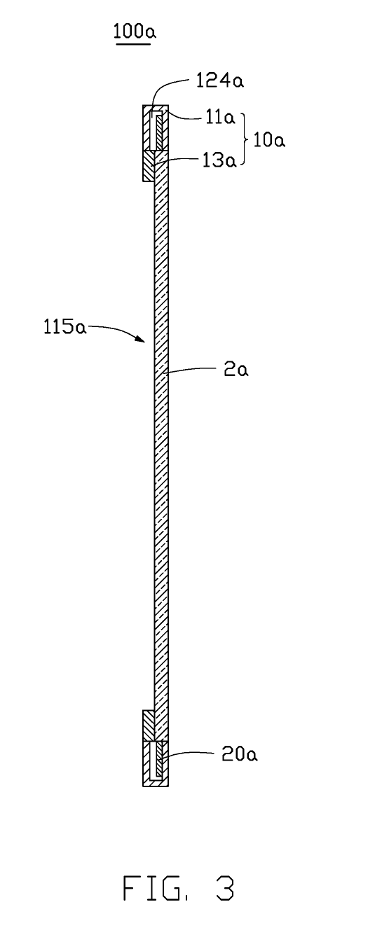

In other exemplary embodiments, the base board 12 can be omitted as shown in FIG. 3 according to a second exemplary embodiment of an ultra-thin television 100a. The ultra-thin television 100a in the second exemplary embodiment is similar to the ultra-thin television 100 in the first exemplary embodiment. Differences between the embodiments include the front frame 11 defining at least one accessory receiving cavity 124a in the front frame 11. The at least one accessory receiving cavity 124a is in air communication with the display screen receiving space 115a. The plurality of accessories 20a is received in the at least one accessory receiving cavity 124a.

The plurality of accessories being separate from the liquid crystal display screen and the plurality of accessories being received in the accessory receiving cavity of the support structure reduce the thickness of the ultra-thin television.

The exemplary embodiments shown and described above are only examples. Many details are often found in the art such as the other features of an ultra-thin television. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the sections within the principles of the present disclosure, up to and including the full extent established by the broad general meaning of the terms used in the claims. It will therefore be appreciated that the exemplary embodiments described above may be modified within the scope of the claims.

What is claimed is:

1. A support structure, used for television comprising:
a front frame having a decorative front surface;
wherein the front frame defines a display screen receiving space;
wherein the support structure defines at least one accessory receiving cavity for receiving accessories, and the at least one accessory receiving cavity is in air communication with the display screen receiving space.

2. The support structure of claim 1, wherein the front frame further has a back surface, a plurality of inner side surfaces, and a plurality of outer side surfaces; wherein the back surface is on a side of the front frame opposite to the decorative front surface, the plurality of inner side surfaces are connected to the back surface and the decorative front surface, and the plurality of outer side surfaces are connected to the back surface and the decorative front surface; and wherein the plurality of inner side surfaces defines the display screen receiving space.

3. The support structure of claim 2, wherein the at least one accessory receiving cavity is defined in the front frame.

4. The support structure of claim 2, wherein the support structure further comprises a base board received in the display screen receiving space away from the decorative front surface, a thickness of the base board is less than a thickness of the front frame defining the display screen receiving space, the at least one accessory receiving cavity is defined in the base board.

5. The support structure of claim 4, wherein the base board comprises a first plate and a second plate; the second plate is on a side of the base board opposite to the first plate, the at least one accessory receiving cavity is defined between the first plate and the second plate, the first plate defines an opening, the at least one accessory receiving cavity is in air communication with the display screen receiving space through the opening.

6. The support structure of claim 1, wherein the support structure further comprises a resisting frame received in the display screen receiving space near the decorative front surface.

7. A wall holder, used for television, comprising:
a support structure comprising:
a front frame having a decorative front surface;
wherein the front frame defines a display screen receiving space;
wherein the support structure defines at least one accessory receiving cavity for receiving accessories, the at least one accessory receiving cavity is in air communication with the display screen receiving space; and
a plurality of accessories received in the at least one accessory receiving cavity;
wherein the plurality of accessories converges to a connector and electrically connects to the connector.

8. The wall holder of claim 7, wherein the front frame further has a back surface, a plurality of inner side surfaces, and a plurality of outer side surfaces; wherein the back surface is on a side of the front frame opposite to the decorative front surface, the plurality of inner side surfaces are connected to the back surface and the decorative front surface, and the plurality of outer side surfaces are connected to the back surface and the decorative front surface; and wherein the plurality of inner side surfaces defines the display screen receiving space.

9. The wall holder of claim 8, wherein the at least one accessory receiving cavity is defined in the front frame.

10. The wall holder of claim 8, wherein the support structure further comprises a base board received in the display screen receiving space away from the decorative front surface, a thickness of the base board is less than a thickness of the front frame defining the display screen receiving space.

11. The wall holder of claim 10, wherein the at least one accessory receiving cavity is defined in the base board.

12. The wall holder of claim 11, wherein the base board comprises a first plate and a second plate; the second plate is on a side of the base board opposite to the first plate, the at least one accessory receiving cavity is defined between the first plate and the second plate, the first plate defines an opening, the at least one accessory receiving cavity is in air communication with the display screen receiving space through the opening.

13. The wall holder of claim 8, wherein the support structure further comprises a resisting frame received in the display screen receiving space near the decorative front surface.

14. A ultra-thin television, comprising:
a wall holder, comprising:
a support structure, comprising:
a front frame having a decorative front surface;
wherein the front frame defines a display screen receiving space;
wherein the support structure defines at least one accessory receiving cavity for receiving accessories, the at least one accessory receiving cavity is in air communication with the display screen receiving space; and
a plurality of accessories received in the at least one accessory receiving cavity;
wherein the plurality of accessories converges to a connector and electrically connects to the connector; and
a liquid crystal display screen received in the display screen receiving space;
wherein the liquid crystal display screen electrically connects to the plurality of accessories through the connector.

15. The ultra-thin television of claim 14, wherein the front frame further has a back surface, a plurality of inner side surfaces, and a plurality of outer side surfaces; wherein the back surface is on a side of the front frame opposite to the decorative front surface, the plurality of inner side surfaces are connected to the back surface and the decorative front surface, and the plurality of outer side surfaces are connected to the back surface and the decorative front surface; and wherein the plurality of inner side surfaces defines the display screen receiving space.

16. The ultra-thin television of claim 15, wherein the at least one accessory receiving cavity is defined in the front frame.

17. The ultra-thin television of claim 15, wherein the support structure further comprises a base board received in the display screen receiving space on back of the liquid crystal display screen, a thickness of the base board is less than a thickness of the front frame defining the display screen receiving space.

18. The ultra-thin television of claim 17, wherein the at least one accessory receiving cavity is defined in the base board.

19. The ultra-thin television of claim 18, wherein the base board comprises a first plate and a second plate, the second plate is on a side of the base board opposite to the first plate, the at least one accessory receiving cavity is defined between the first plate and the second plate, the first plate defines an opening, the at least one accessory receiving cavity is in air communication with the display screen receiving space through the opening.

20. The ultra-thin television of claim 14, wherein the support structure further comprises a resisting frame received in the display screen receiving space on front of the liquid crystal display screen.
